(19) United States
(12) Patent Application Publication
(10) Pub. No.: US 2010/0149133 A1
(43) Pub. Date: Jun. 17, 2010

(54) Display device having touch screen function

(75) Inventors: Seok-Gyun Woo, Suwon-si (KR); Sang-Hoon Yim, Suwon-si (KR); Seong-Gi Choo, Suwon-si (KR)

Correspondence Address: ROBERT E. BUSHNELL & LAW FIRM, 2029 K STREET NW, SUITE 600, WASHINGTON, DC, 20006-1004, US

(73) Assignee: SAMSUNG SDI CO., LTD, Suwon-si (KR)

(21) Appl. No.: 12/591,939

(22) Filed: Dec. 4, 2009

(30) Foreign Application Priority Data
Dec. 16, 2008 (KR) 10-2008-0128201

(51) Int. Cl. G06F 3/042

(52) U.S. Cl. 345/175

(57) ABSTRACT

A display device has a display panel generating visible light and generating infrared rays; a plurality of detectors detecting a change in an intensity of the infrared rays generated by the display panel; and the plurality of detectors recognizing a touch applied to the display panel in dependence upon the change detected in the intensity of the infrared rays.

### CLAIM OF PRIORITY

This application makes reference to, incorporates the same herein, and claims all benefits accruing under 35 U.S.C. §119 from an application earlier filed in the Korean Patent Office on 16 Dec. 2008 and there duly assigned Serial No. 10-2008-0128201.

### BACKGROUND OF THE INVENTION

1. Field of the Invention

The present invention relates to a display device having a touch screen function, and more particularly, to a display device having a touch screen function by using infrared rays obtained by a light emitting mechanism performed by the display device.

2. Description of the Related Art

A display panel having a touch screen function generally refers to a display panel which can detect the presence and location of a touch applied by an external object within the displaying area of the display panel. The term, touch, includes a physical contact to the display device by a human's finger. Contemporary display panels having the touch screen function may be formed in various types including an infrared ray type, a resistance film type, an electric capacity type, an ultrasonic wave type, and a pressure sensor type. For a large screen panel, such as a plasma display panel, the display panel is generally formed as an infrared ray type touch panel in order to conveniently realize the touch screen function on this large screen panel.

As an example of the contemporary touch screen device, Korean Patent Publication No. 1998-0041328 discloses a touch screen device of a plasma display panel (PDP) television (TV), this touch screen device includes: a perpendicular infrared ray generator, which generates a perpendicular infrared ray signal and is disposed on one of top and bottom sides of a screen; a perpendicular infrared ray receiver, which receives the perpendicular infrared ray signal and is disposed on the other side of the screen to the perpendicular infrared ray generator; a horizontal infrared ray generator, which generates a horizontal infrared ray signal and is disposed on one of left and right sides of the screen; a horizontal infrared ray receiver, which receives the horizontal infrared ray signal and is disposed on the other side of the screen to the horizontal infrared ray generator; a controller which controls each of the perpendicular infrared ray generator and the horizontal infrared ray generator; a calculator for calculating a coordinate value due to user touch manipulation, based on the perpendicular and horizontal infrared ray signal; and an interface means for outputting the calculated coordinate value to a control system.

In order to realize a touch screen function in the contemporary display panel having a large screen, however, the display panel having the large screen requires the incorporation into the display panel both the infrared rays source which generates the infrared ray and an infrared ray sensor which detects the infrared rays generated.

Even though a plasma display panel of the display device may emit infrared rays, the contemporary plasma display device still requires an additional infrared ray source and an infrared ray sensor which must be continuously powered during use of the in order to successfully realize the touch panel function. Therefore, additional heat may be disadvantageously generated, the cost of manufacture of the display panels may significantly increase, and unnecessary power wastage may occur over a span of many years.

### SUMMARY OF THE INVENTION

It is therefore one object of the present invention to provide an improved touch screen display panel.

It is another object to provide a display panel having a touch screen function, which eliminates the need of installation of an additional infrared ray source in the display panel.

It is still another object to provide a display panel having a touch screen function by sensing light that is emitted by the display panel and thus forming an image on the display panel by utilizing the light emitted by the display panel.

In accordance with an exemplary embodiment of the present invention, a display device having a touch screen function, may include a display panel which emits light and forms an image on the display panel; and a plurality of detectors which indicate the occurrence, and location, of a touch applied on the display panel by a human being, detecting intensity of the light emitted from the display panel.

The plurality of detectors may be disposed on edges of a front surface of the display panel.

The plurality of detectors may be disposed on corners of a front surface of the display panel.

When the number of the plurality of detectors is two (2), the detectors may be disposed on neighboring corners among the several corners that are formed along the periphery of the display panel, may have directivity for detecting light, and may be arranged such that central paths of the detectors cross each other.

When the number of the plurality of detectors is two (2), the detectors may be respectively disposed on two corners formed at two opposite ends of a diagonal of the display panel, may be arranged such that central paths of the detectors cross each other, and have directivity for detecting light.

When the number of the plurality of detectors is four (4), the detectors may be disposed on neighboring corners among the corners of the display panel, may be arranged such that central paths of the detectors cross each other, and may have directivity for detecting light.

When the number of the plurality of detectors is at least three (3), the display device may have a function simultaneously detecting multiple applied touches.

The plurality of detectors may be disposed at a predetermined angle with respect to the display surface of the display panel so as to detect the light.

The plurality of detectors may measure the intensity of the light, and detect location on the display panel when the intensity of the light changes.

The plurality of detectors may be any one of a photodiode, a photo transistor, and an infrared ray camera.

The light emitted may be infrared rays.

The display panel may include a first area in which an image is displayed and in which the light is emitted; and a second area which is surrounded by the first area and in which the light is not emitted, wherein the plurality of detectors are disposed in the second area.

The display device may further include a filter which is disposed on the display panel, and the filter may be formed so that light to be detected by the plurality of detectors can penetrate through the filter.

The light detected by the plurality of detectors may be infrared rays.

The permeability of the infrared ray of the filter may be at least 90%.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a plan view illustrating a plane structure of a display device constructed as an embodiment of the present invention;

FIG. 2 is a partial cross-sectional view of the display device taken along a line II-II of FIG. 1;

FIG. 3 is an exploded oblique view of the display device of FIG. 1;

FIG. 4 is an exploded oblique view illustrating a structure of a display panel assembled with a case;

FIG. 5 is a diagram illustrating a modified example of the display device of FIG. 1 constructed as another embodiment of the present invention;

FIG. 6 are diagrams of signal traces respectively illustrating electrical waveforms representing intensity of infrared rays detected by first and second detectors, when there is no touch applied on a display panel; and

FIG. 7 are diagrams of signal traces respectively illustrating electrical waveforms representing variations in the intensity of infrared rays detected by first and second detectors, when locations A, B, and C of FIG. 1 are respectively touched by a human user of the display device.

### DETAILED DESCRIPTION OF THE INVENTION

Hereinafter, the present invention will be described more fully with reference to the accompanying drawings, and exemplary embodiments of the present invention will be shown.

As those skilled in the art would realize, the described embodiments may be modified in various different ways, all without departing from the spirit or scope of the principles for the present invention.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, elements extrinsic to the description are omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

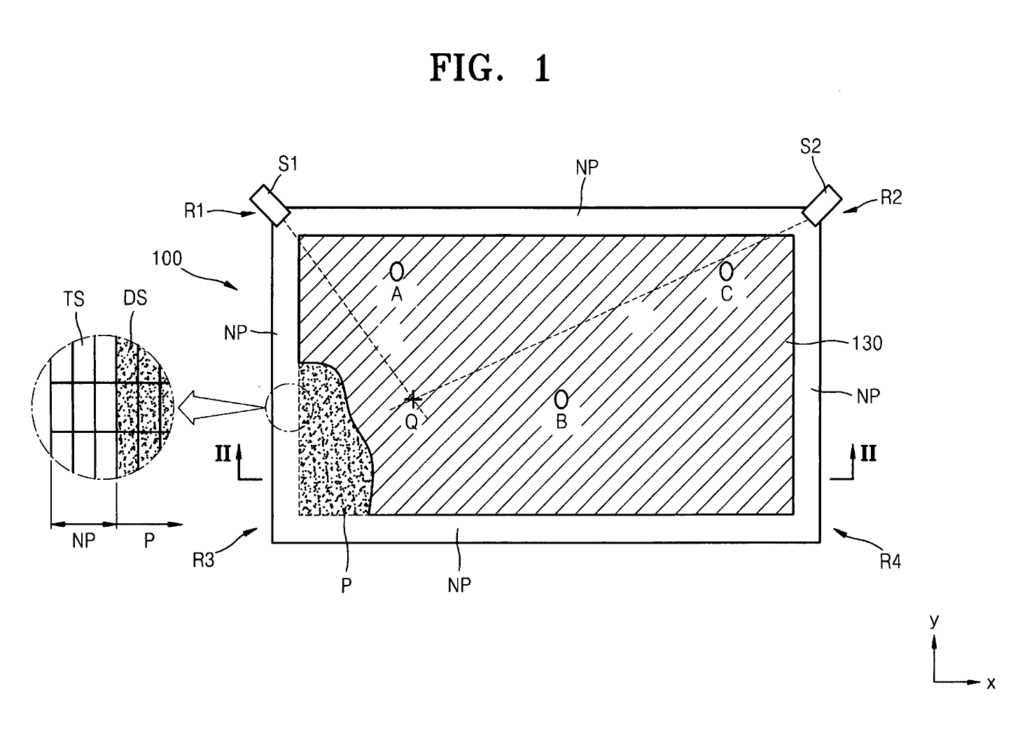

FIG. 1 is a plan view illustrating a plane structure of a display device constructed as an embodiment of the present invention. The display device as illustrated in FIG. 1 may include a display panel 100, which displays a predetermined image; and first and second detectors S1 and S2, which optically detect a predetermined location Q on display panel 100 when a touch is applied against a major surface on display panel 100. Display panel 100 includes a first area P for displaying an image, and a plurality of discharge cells DS are formed within the first area P. A second area NP, which does not display any image, is prepared and disposed at an outer portion of display panel 100, i.e., at outer lengthwise portions of the first area P and outer widthwise portions of the first area P, and dummy cells TS are formed in the second area NP. The dummy cells TS disposed in the second area NP may be formed in a band-shape and may be arranged as a peripheral border to surround the first area P.

Each discharge cell DS disposed at the first area P is the smallest unit which emits light used to display a predetermined image. The discharge cell DS emits light having a predetermined color by using a method of plasma discharge. Neighboring discharge cells which emit light having different colors may form a pixel, i.e., a dot on the display screen of the display panel. Each of the discharge cells DS includes a pair of electrodes that stimulate the plasma discharge, and is able to create a gray scale by emitting light by using an input controlled signal during a portion of a predetermined duration.

Dummy cells TS are used to provide a predetermined space which may compensate for a process error that may occur during the manufacture of display panel 100, and dummy cells TS are not formed to generate discharge of light for the display of an image. Dummy cell TS may not include all of a common electrode, a scanning electrode, and an address electrode, wherein the common electrode and the scanning electrode generate mutual discharge, and the address electrode generates addressing discharge.

The first and second detectors S1 and S2, which receive a light intercepting signal, are disposed on edges of display panel 100. The central path of the first detector S1 is indicated by path L1, and the central path of the second detector S2 is indicated by path L2. The central paths of the detectors may intercept, and cross each other. The first and second detectors S1 and S2, as illustrated in FIG. 1, may be disposed on first and second corners R1 and R2. For example, the first corner R1 may be the upper left corner of display panel 100; and the second corner R2 may be the upper right corner of display panel 100. Here, the first detector S1 that is disposed on the upper left corner may be tilted at a predetermined angle in order to face a fourth corner R4, and the second detector S2 that is disposed on the upper right corner may be tilted at a predetermined angle in order to face a third corner R3.

Alternatively, the first and second detectors S1 and S2 may be respectively disposed on two corners formed at two opposite ends of a diagonal of display panel 100. As an embodiment of the present invention, the first detector S1 may be disposed on the first corner R1, and the second detector S2 may be disposed on the fourth corner R4. As another embodiment of the present invention, the first detector S1 may be disposed on the second corner R2, and the second detector S2 may be disposed on the third corner R3.

The first and second detectors S1 and S2 may each be a either photodiode, a phototransistor, or an infrared ray camera. The infrared ray camera may be any camera where a photoelectric device, such as a charge coupled device (CCD) or a complementary metal oxide semiconductor (CMOS) image sensor, is disposed on a two dimensional plane.

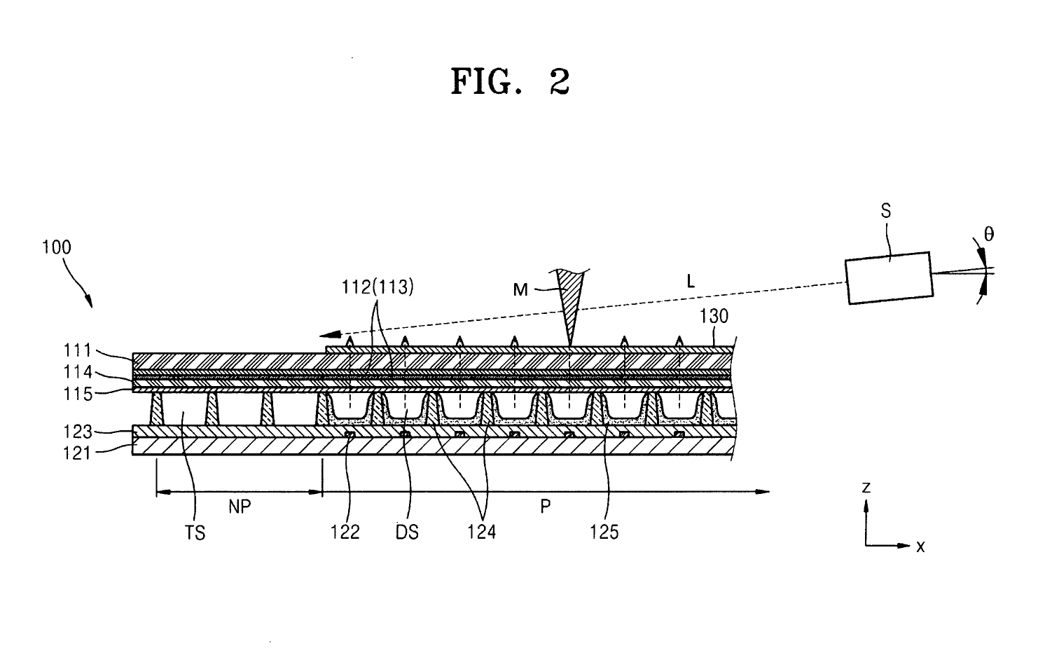

FIG. 2 is a cross-sectional partial view of display panel 100 taken along a line II-II of FIG. 1. Referring to FIG. 2, barrier ribs 124 are disposed between front substrate 111 and rear substrate 121, and these two substrates face toward each other. Accordingly, the discharge cells DS are partitioned in the first area P and the dummy cells TS are partitioned in the second area NP. In this touch screen structure, the discharge cells DS are used as a light source and the first and second detectors S1 and S2 are used as optical receivers. Here, the discharge cells DS not only emit visible rays displaying images on the screen but also emit infrared rays (IR infrared rays) for realizing the touch screen function. Furthermore, the first and second detectors S1 and S2 are tilted at a predetermined angle θ with respect to the major surface of display panel 100, and an optical acquisition path of the detectors S (e.g., the first detector S1 and the second detector S2) may be disposed along an oblique direction L with respect to the first area P. Therefore, the detectors may effectively detect the light emitted from the display panel. When an external object M, such as a finger or a pen, touches a predetermined location on the first area P, the first and second detectors S1 and S2 detect a portion where the detected optical intensity is remarkably decreased on a photographed image, because of the interception of an optical acquisition path to the first and second detects S1 and S2. Therefore, an accurate touched location is determined by the first and second detectors S1 and S2 by detecting the portion where the optical intensity is remarkably decreased.

Filter 130 may be disposed on front substrate 111. Filter 130 may be penetrated by light emitted from display panel 100. The discharge cells DS of the display panel 100 not only emit visible rays that are used to form an image on the screen, but also emit infrared rays which act as a light source for realizing the touch panel function on display panel 100. Accordingly, filter 130 may be penetrated by the infrared rays emitted from the discharge cells DS. For example, filter 130 may be penetrated by at least 90% of the infrared rays emitted from the discharge cells DS.

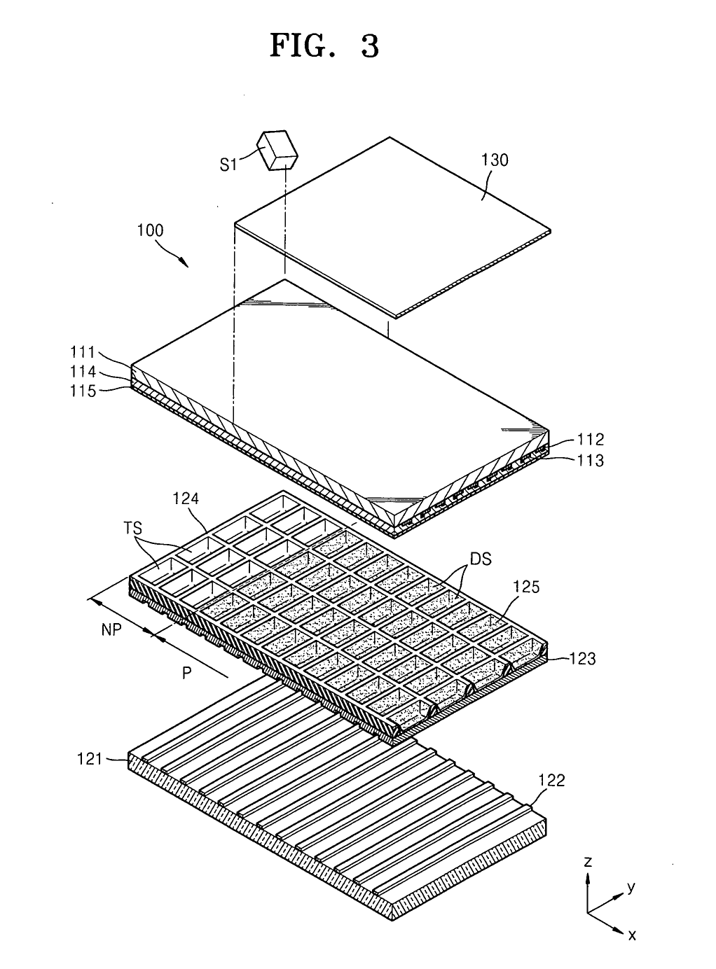

FIG. 3 is an exploded perspective view of display device 100 of FIG. 1. Referring to FIG. 3, a pair of front substrate 111 and rear substrate 121 is disposed to face to each other, and barrier ribs 124 are disposed between front and rear substrates 111 and 121. Accordingly, the plurality of discharge cells DS are partitioned in the first area P and the plurality of dummy cells TS are partitioned in the second area NP. A plurality of pairs of common electrodes 112 and scanning electrodes 113 for generating mutual discharge are arranged on front substrate 111. Address electrodes 122, which generate addressing discharge with scanning electrodes 113, may be formed on rear substrate 121. Dielectric layers 114 and 123 may be formed on front and rear substrate 111 and 121 so as to embed and protect corresponding electrodes 112, 113, and 122. Also, protective layer 115 covering dielectric layer 114 may be further formed on front substrate 111.

Common electrodes 112, scanning electrodes 113, and address electrodes 122 may be formed both inside of, and outside of, the first area P, and the discharge cells DS formed within the first area P may generate suitable discharge by using electrodes 112, 113, and 122 in order to realize a prearranged light emission function. By simultaneously manufacturing electrodes 112, 113, and 122, therefore, electrodes 112, 113, and 122 may be uniformly formed throughout both the inside and outside of first area P.

Address electrode 122 generates addressing discharge with scanning electrode 113 and selects at least one of the discharge cells DS to generate a discharge. Each of the discharge cells DS disposed on the inner surfaces of the first area P may generate a discharge by a number of times, for predetermined durations so as to provide a luminance distribution (i.e., a gray scale) in order to create an image to be displayed. In another embodiment, when common electrode 112 and scanning electrode 113 are disposed to cross each other, address electrode 122 may be omitted and common electrode 112 may perform the functions of address electrode 122.

Phosphor substances 125 may be coated on an inner surface of the discharge cells DS. Phosphor substrates 125 absorb ultraviolet rays generated by the discharge, and convert the ultraviolet rays that are thus generated into visible rays. Phosphor substrates 125 may be roughly classified into red (R), green (G), and blue (B) phosphor substances in accordance with the colors of the emitted light.

Discharge gas is injected to fill the space between front substrate 111 and rear substrate 121. The discharge gas may be multi-component gas, which includes xenon (Xe) that generates suitable infrared rays and ultraviolet rays via discharge excitation, and includes krypton (Kr), helium (He), and neon (Ne) in a determined volume ratio. For example, while xenon is ionized by reacting with a high electric field discharge voltage applied between the common electrode 112 and the scanning electrode 113, electrons in xenon transit to a multiple of energy levels, thereby generating infrared rays and ultraviolet rays of predetermined wavelengths. Such a series of discharge processes are commonly performed in the discharge cells DS containing the discharge gas. The infrared rays generated by the display panel have the same or better functionality as the infrared rays generated by the additional infrared rays source known in the art.

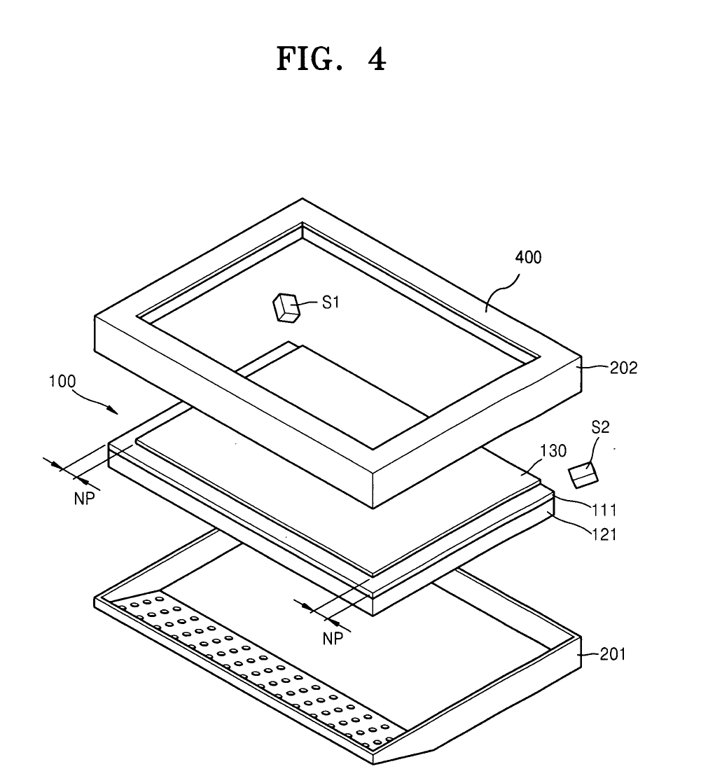

FIG. 4 is a perspective view illustrating a structure of display panel 100 of FIG. 3 assembled into a case. As illustrated in FIG. 4, display panel 100 is contained in an internal space formed between front case 202 and rear case 201, which are assembled together with each other. The second area NP, which does not perform a display function, may be covered by edges 400 of front case 202, and visible rays otherwise, or mistakenly emitted by those dummy cells TS located within the second area NP may be blocked by edges 400 and thus deterioration of display quality is prevented.

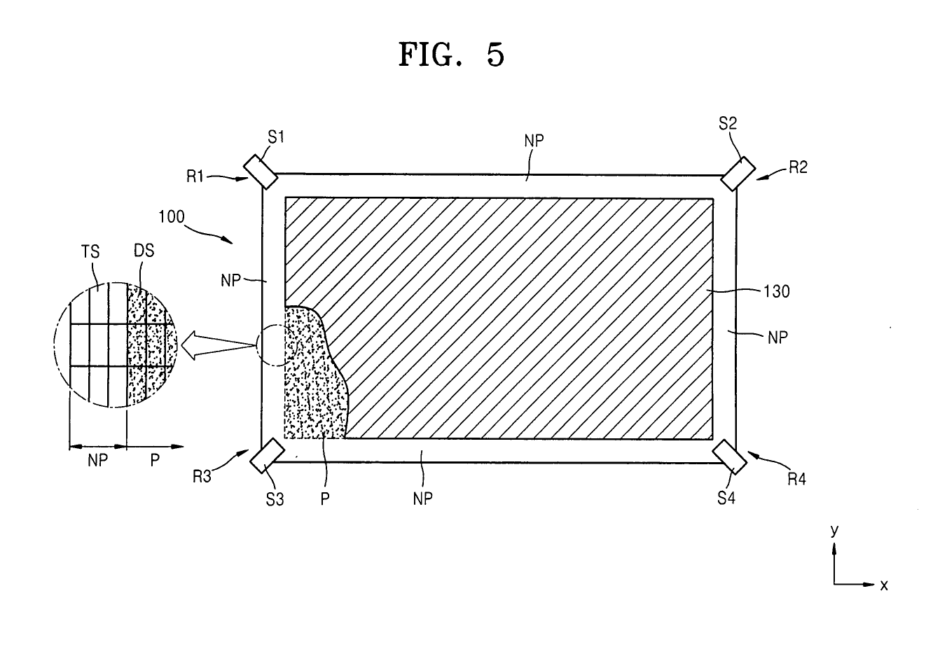

FIG. 5 is a diagram illustrating a modified example of the display device of FIG. 1 constructed as another embodiment of the present invention. Display device 100 as shown in FIG. 5 has structure similar to the display device shown in FIG. 1, except for the detectors. As illustrated in FIG. 5, the rectangular-shaped first area P is prepared substantially at the center of display panel 100. The first area P includes the plurality of discharge cells DS to form a predetermined image. Also, the dummy cells TS are arranged within the second area NP, which surrounds the first area P along upper, lower, right, and left sides of the first area P. First, second, third, and fourth detectors S1, S2, S3, and S4 for receiving a light intercepting signal are arranged on each of corners R1, R2, R3, and R4 of the second area NP. By arranging the dummy cells TS along the upper, lower right, and left sides that surround the first area P, and by arranging the first through fourth detectors S1 through S4 receiving optical signals at each of the corners R1, R2, R3, and R4, dead zones of the first through fourth detectors S1 through S4 may be effectively eliminated, and thus removed, and an accurate touched location may be reliably detected with a high degree of precision.

At least three detectors may be used in order to guarantee to realize a multi-touch function, which simultaneously detects at least two touch inputs, and the current embodiment is suitable for realizing the multi-touch function.

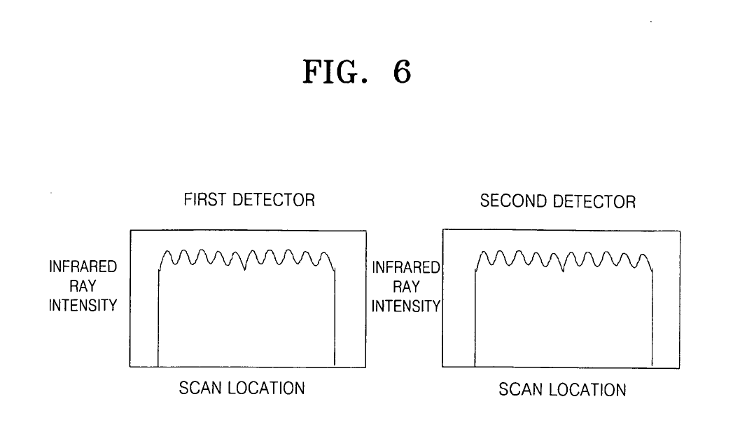

FIG. 6 are orthogonal graphs showing two different waveform traces respectively illustrating electrical signals representing intensities of infrared rays respectively detected by first and second detectors, when there is no touch applied to a display panel. As shown in FIG. 6, when there is no touch applied within the first area P, the signal representing infrared ray intensity measured by the first and second detectors S1 and S2 only includes a ripple signal component representing an approximately unchanged infrared ray intensity, and does not have any signal component representing a remarkable change in the infrared ray intensity.

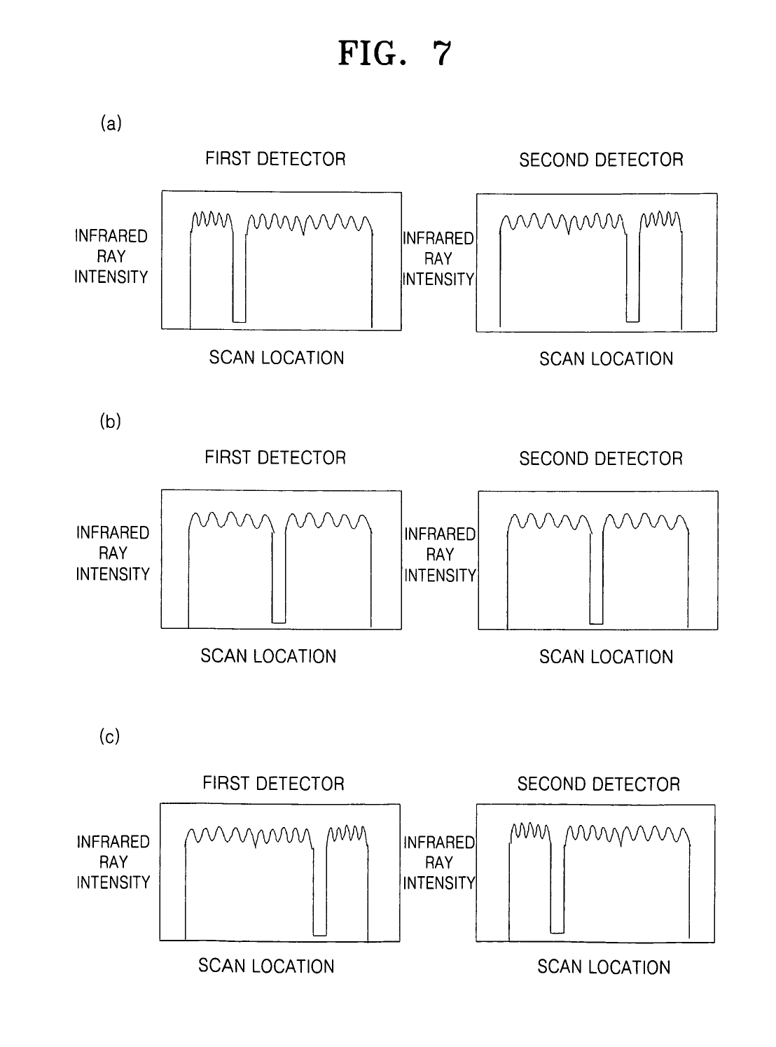

FIG. 7 are orthogonal graphs showing different waveform traces respectively illustrating electrical signals representing the intensities of infrared rays respectively detected by first and second detectors, when locations A, B, and C of FIG. 1 are respectively touched. When the first area P is touched, the infrared ray intensity detected by the first and second detectors S1 and S2 clearly shows a remarkable change because of the light interception. When locations A, B, C on the first area P are respectively touched and scan directions of the first and second detectors S1 and S2 are as illustrated in FIG. 1, the intensity of infrared rays detected by the first and second detectors S1 and S2 is remarkably reduced at a certain identifiably locations with respect to the scan direction of the detectors. The scan directions of the detectors may be determined by a designer of the display panel, and the detectors should scan the entire display panel.

As illustrated in FIG. 7 (a), when the location A is touched, a remarkable drop in infrared rays intensity is observed at a left scan location of the first detector S1 and a remarkable drop in the intensity of infrared rays is observed at a right scan location of the second detector S2. As illustrated in FIG. 7 (c), when the location C is touched, a remarkable drop in infrared rays intensity is observed at a right scan location of the first detector S1 and a remarkable drop in intensity is observed at a left scan location of the second detector S2. Also as illustrated in FIG. 7 (b), when the location B, which is at the center of display panel 100, is touched, remarkable drops in the intensity of infrared rays are observed at center scan locations of the first and second detectors S1 and S2. This method according to the presented invention can be used to identify the precise location as two dimensional position of a touch applied against the exposed surface of the display panel.

A display device constructed as an embodiment of the present invention is endowed with a touch screen function by using infrared rays generated by a light emitting mechanism of the display panel that is used to simultaneously generate varying visual images formed for the user. Accordingly, the installation of an infrared ray source, such as a LED array, is not required thus reducing the costs incurred, while a precise touch screen having a resolution as high as the resolution of an image displayed by the screen may be provided.

According to the display device, the costs of manufacturing the display device are significantly reduced, since infrared rays emitted from the display panel are used without using a separate infrared ray source.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display device having a touch screen function, the display device comprising:
a display panel which emits light and displays an image; and
a plurality of detectors which detect a touch applied on the display panel by detecting intensity of the light emitted by the display panel.

2. The display device of claim 1, with the plurality of detectors being disposed on edges of a front surface of the display panel.

3. The display device of claim 1, with the plurality of detectors being disposed on corners of a front surface of the display panel.

4. The display device of claim 3, when the number of the plurality of detectors is two, the detectors being disposed on neighboring corners among the corners of the display panel, facing to the light emitted by the display device, and being arranged such that central paths of the detectors cross each other.

5. The display device of claim 3, when the number of the plurality of detectors is two, the detectors being respectively disposed on two corners formed at two opposite ends of diagonal of the display panel, being arranged such that central paths of the detectors cross each other, and having directivity for detecting light.

6. The display device of claim 3, when the number of the plurality of detectors is four, the detectors being disposed on neighboring corners among the corners of the display panel, being arranged such that central paths of the detectors cross each other, and having directivity for detecting light.

7. The display device of claim 1, when the number of the plurality of detectors is at least three, the display device having a function simultaneously detecting multiple touches applied to the display device.

8. The display device of claim 1, with the plurality of detectors being disposed at a predetermined angle with respect to a surface of the display panel.

9. The display device of claim 1, with the plurality of detectors measuring light intensity, and detecting location on the display panel where a change in intensity of light is detected.

10. The display device of claim 1, with the plurality of detectors being any one of a photodiode, a photo transistor, and an infrared ray camera.

11. The display device of claim 1, with the light being infrared rays.

12. The display device of claim 1, with the display panel further comprising:
a first area where the image is formed and where the light is emitted;
a second area which is surrounded by the first area and where the light is not emitted, and
the plurality of detectors being disposed in the second area.

13. The display device of claim 1, further comprising a filter which is disposed on the display panel, and the filter being formed so as the light to be detected by the plurality of detectors penetrates through the filter.

14. The display device of claim 13, the light detected by the plurality of detectors being infrared rays.

15. The display device of claim 14, wherein a permeability of the infrared ray of the filter is at least 90%.

16. A display device, comprising:
a display panel generating visible light and generating infrared rays;
a plurality of detectors detecting a change in an intensity of the infrared rays generated by the display panel; and
the plurality of detectors recognizing a touch applied to the display panel in dependence upon the change detected in the intensity of the infrared rays.

17. A display device, comprising:
a display panel generating infrared rays and displaying variable images by generating visible light;
a plurality of detectors disposed on corners of the display panel at a predetermined angle with respect to a surface of the display panel, the plurality of the detectors detecting a change in intensity of the infrared rays by scanning the entire display panel; and
the plurality of detectors determining the touch applied by an object to the display panel by using the detected change of the intensity of the infrared rays.

18. The display panel of claim 17, with the plurality of detectors oriented at predetermined angles to a viewing surface of the display panel.

19. The display panel of claim 18, with the plurality of detectors disposed in an array along a periphery of the display panel.
